(19) United States
(12) Patent Application Publication
(10) Pub. No.: US 2016/0371885 A1
(43) Pub. Date: Dec. 22, 2016

(54) SHARING OF MARKUP TO IMAGE DATA

(71) Applicants: Anatolie Gavriliuc, Kirkland, WA (US); Dan Osborn, Woodinville, WA (US); Steve Heijster, Kirkland, WA (US); Hongwu Huai, San Bruno, CA (US); Albert Robles, Redmond, WA (US); Nicolas Gauvin, Redmond, WA (US)

(72) Inventors: Anatolie Gavriliuc, Kirkland, WA (US); Dan Osborn, Woodinville, WA (US); Steve Heijster, Kirkland, WA (US); Hongwu Huai, San Bruno, CA (US); Albert Robles, Redmond, WA (US); Nicolas Gauvin, Redmond, WA (US)

(21) Appl. No.: 14/746,693

(22) Filed: Jun. 22, 2015

(51) Int. Cl. G06T 19/00; G06T 19/20; G06T 13/00; G06F 3/0484; G06T 7/00; G06T 11/20

(52) U.S. Cl. CPC G06T 19/006; G06T 7/0051; G06T 11/20; G06T 13/00; G06F 3/04845; G06T 19/20; G06T 2219/024

(57) ABSTRACT

Examples are disclosed herein that relate to sharing of depth-referenced markup in image data. One example provides, on a computing device, a method comprising receiving image data of a real world scene and depth data of the real world scene. The method further includes displaying the image data, receiving an input of a markup to the image data, and associating the markup with a three-dimensional location in the real world scene based on the depth data. The method further comprises sending the markup and the three-dimensional location associated with the markup to another device.

### BACKGROUND

Images of real world scenes may be captured via a camera and shared with others for many purposes. Some images may be marked up with other content, such as instructions or highlighting of certain image features, to convey additional information relevant to the image to a recipient of the image.

### SUMMARY

Examples are disclosed herein that relate to sharing of depth-referenced markup in image data. One example provides, on a computing device, a method comprising receiving image data of a real world scene and depth data of the real world scene. The method further includes displaying the image data, receiving an input of a markup to the image data, and associating the markup with a three-dimensional location in the real world scene based on the depth data. The method further comprises sending the markup and the three-dimensional location associated with the markup to another device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example use environment for the sharing of depth-referenced markup for image data, and illustrates an example augmented reality display device and an example other display device sharing image data and markup.

FIG. 2A illustrates an example presentation of image data captured by the augmented reality display device of FIG. 1 and shared with the other display device.

FIG. 2B shows an example input of markup to the image data of FIG. 1 made via the other display device of FIG. 1.

FIG. 3A shows an example presentation of the markup of FIG. 2B on the augmented reality display device of FIG. 1.

FIG. 3B shows presentation of the markup of FIG. 2B via the augmented reality display device of FIG. 1 from a different perspective in the environment.

FIG. 4A shows an example of a user interaction with the presentation of markup of FIGS. 3A-B.

FIG. 4B shows an example input of additional markup to image data of the environment of FIG. 1.

FIG. 5 shows an example presentation of the additional markup of FIG. 4B by the other display device.

FIG. 6 is a flowchart illustrating an example method of sharing markup for image data.

FIG. 7 shows a block diagram of an example augmented reality display system.

FIG. 8 shows a block diagram of an example computing system.

### DETAILED DESCRIPTION

As mentioned above, a person may mark up an electronic image of an object, setting, etc. with various types of data, such as drawings, text, other images, etc. to augment the image. The addition of such supplementary data to an image may allow the person to conveniently share thoughts, ideas, instructions, and the like with others. However, such augmentation is often referenced to a two-dimensional location within a coordinate frame of the image. As such, the augmentation may not be suitable for display in an augmented reality setting, in which a see-through display device displays virtual objects that may be referenced to a three-dimensional real-world coordinate frame.

Further, even where the image coordinate frame can be mapped to a real-world coordinate frame for augmented reality display, markup that is added to an image having two dimensional data may not display in an intended location in an augmented reality environment, as such markup lacks depth information that can be used to generate a realistic stereoscopic rendering of the markup such that it appears at an intended depth in the image.

Accordingly, examples are disclosed herein that relate to referencing markup made to two dimensional image data to a three-dimensional location by referencing the markup to depth data associated with the image data. This may allow the markup to be viewed via augmented reality technologies at an intended three-dimensional location in the real world scene by stereoscopic rendering based upon the depth data, and also viewed in the intended location in other images of the environment, even where taken from different perspectives.

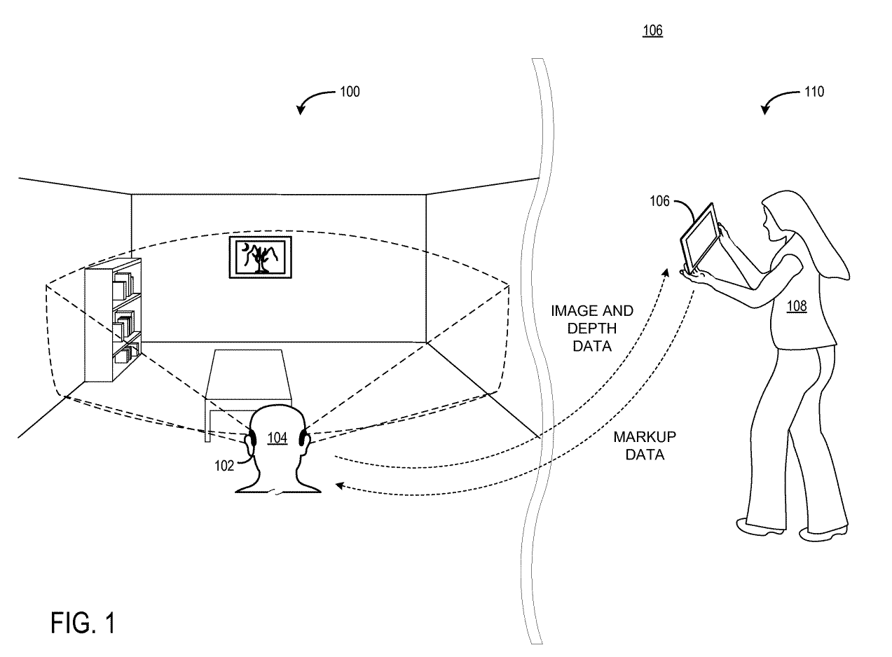

FIG. 1 shows an example use environment 100 for sharing depth-referenced markup for image data. Environment 100 includes an augmented reality display device 102 worn by a user 104. The augmented reality display device 102 includes a see-through display that enables the presentation of virtual content together with a view of the real-world background within an augmented reality field of view 105. The display device 102 further includes an outward-facing image sensor configured to capture image data, such as color image data (e.g. RGB data), of environment 100. The image data be captured in still or video form.

The display device may send captured image data, and also depth data representing environment 100, to a remote display device 106 for presentation to user 108. User 108 may input markup to the image data, for example by entering a handmade sketch via touch input, by inserting an existing drawing or image, etc. using the remote display device 106. The remote display device 106 associates the markup with a three-dimensional location within the environment based upon the location in the image data at which the markup is made, and then may send the markup back to the display device 102 for presentation to user 104 via augmented reality display device 102. Via the markup, user 108 may provide instructions, questions, comments, and/or other information to user 106 in the context of the image data. Further, since the markup is associated with a three-dimensional location in a coordinate frame of the augmented reality environment, user 104 may view the markup as spatially augment reality imagery, such that the markup remains in a selected orientation and location relative to environment 100. This may allow user 104 to view the markup from different perspectives by moving within the environment. It will be understood that, in other implementations, any other suitable type of computing device than a wearable augmented reality display device may be used. For example, a video-based augmentation mode that combines a camera viewfinder view with the markup may be used with any suitable display device comprising a camera to present markup-augmented imagery according to the present disclosure.

In some implementations, depth image data may be acquired via a depth camera integrated with the augmented reality display device 102. In such implementations, the fields of view of the depth camera and RGB camera may have a calibrated or otherwise known spatial relationship. This may facilitate integrating or otherwise associating each frame of RBG data with corresponding depth image data. In other implementations, the display device 102 may retrieve previously acquired and stored depth data of the scene (e.g. a three-dimensional mesh representation of the environment), wherein such depth data may be stored locally or remotely. In such implementations, the display device 102 may be configured to identify the environment 100 via sensor data, such as GPS sensor data and/or image data (e.g. using image recognition techniques to recognize objects in the environment), and then retrieve depth image data for the identified environment. The image data and depth data further may be spatially mapped to one another using this data so that appropriate depth values within the coordinate frame of the may be associated with the pixels of the image data. Such mapping may be performed locally on display device 102 or via a remote service.

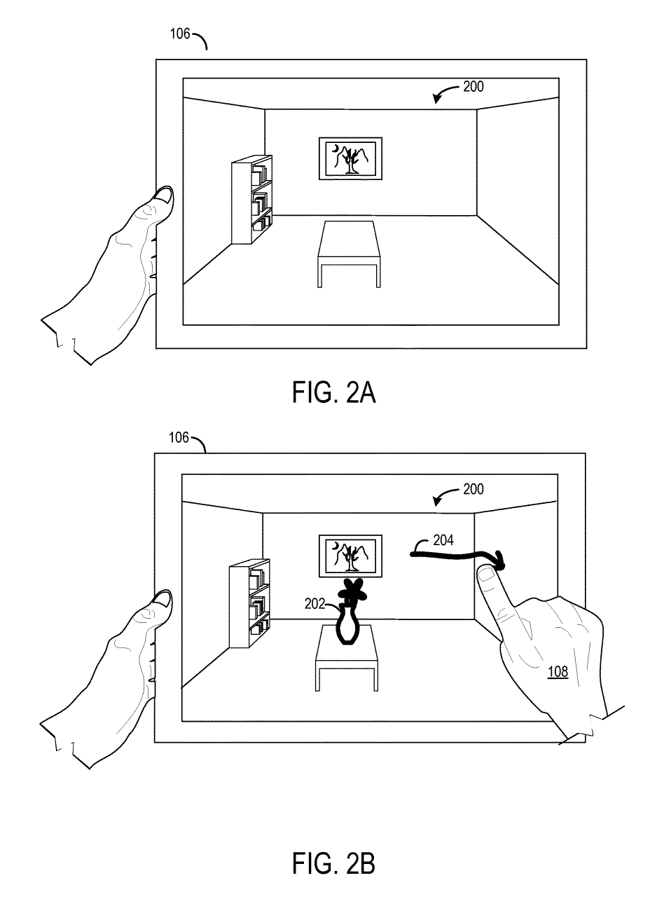

The display device 102 may send the image data and the associated depth data to a remote device, such as to display device 106, or to a server device for storage and later retrieval. Upon receipt, display device 106 may present the image data to user 108, as shown in FIG. 2A. The image data 200 may take any suitable form, such as a still image or a video stream. In any case, the user 108 may insert markup to the image data 200, such as by drawing on the surface of the display device 106 via touch input, or using another input mode (e.g. a cursor controller, such as a touch pad, track ball, mouse, image and/or depth sensor to track body part gestures, etc.). Where video images are shared, the user 108 may pause video playback to input markup, or may input markup to the video during presentation of the video images.

FIG. 2B illustrates an example input of markup to the image data on the display device 106. As depicted, the user 108 has inserted a first drawing 202 of a flower vase illustrating where the user 108 would like to place a vase in environment 100, and a second drawing 204 of an arrow showing where the user 108 would like to move a painting. In this example, the user 108 has inserted the drawings by touch input, but it will be understood that markup to image data may be input in any other suitable manner than touch input.

Each input of markup may be associated with a three-dimensional location in the environment that is mapped to the two-dimensional (i.e. in the plane of the image) location in the image at which the markup was made. For example, in FIG. 2B, the user 108 input the drawing 202 at a location corresponding to the top of a table, and the drawing 204 at a location corresponding to a wall. Thus, the drawings 202, 204 may be associated with the depth locations in the real world scene that are mapped to those locations in the image displayed on display device 106. After receiving input of the markup, computing device 106 may send the markup and associated three-dimensional location of each item of markup to display device 102 for presentation to user 104, to a server for storage and later retrieval, and/or to any other suitable device.

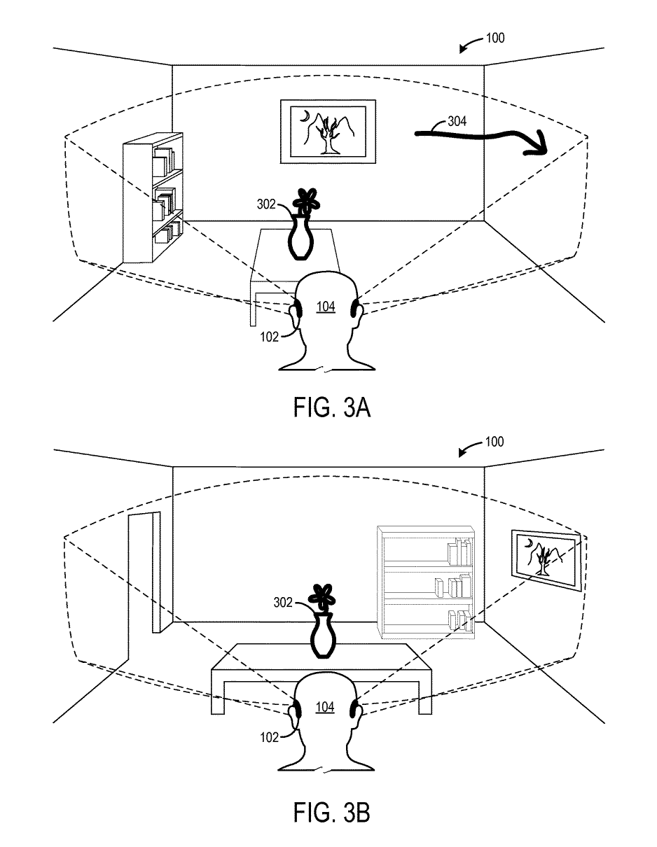

FIG. 3A shows an example of the presentation of the drawings of FIG. 2B. In this example, the drawings 202, 204 are displayed as holographic objects 302, 304 via the see-through display of the display device 102. As depicted, each holographic object 302, 304 appears in the environment 100 at an associated three-dimensional location based upon the location in the shared image at which they were input. As the user 104 moves about within environment 100, the holographic objects 302, 304 may remain in their associated three-dimensional locations within environment 100. For example, FIG. 3B shows the user 104 viewing the environment 100 from a different perspective than that of FIGS. 1 and 3A, where the holographic object 302 remains viewable at the same associated depth locations in the real world scene. In FIG. 3B, holographic object 304 is outside of the region of the see-through display in which holographic objects are displayable.

The drawings 202, 204 also may be displayed in additional image data of the real world scene captured by display device 102 for presentation by display device 106 (and/or other computing devices). For example, as user 102 moves within environment 100, image data sent to display device 106 may include data representing the drawings 202, 204 as viewed from different perspectives, thereby enabling the recipient devices to display the markup along with the image data. Alternately, the markup may not be sent back to display device 106 with additional image data, and the display device 106 may use a locally stored copy of the markup plus three-dimensional locational information received with the additional image data to render the markup in the additional image data from a different perspective.

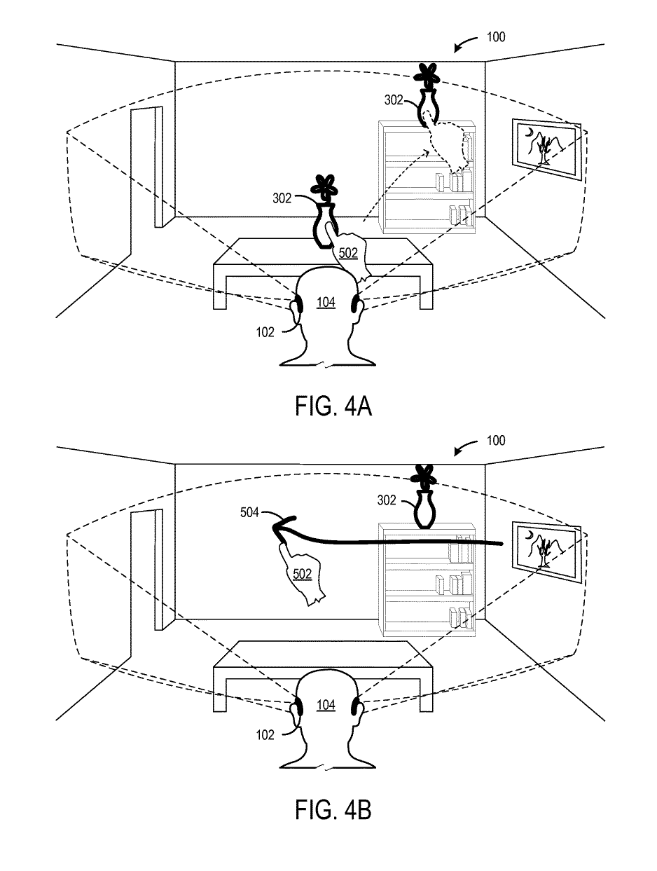

Some implementations may allow a recipient of markup to interact with and/or manipulate the markup, and to modify display of the markup based upon the interaction and/or manipulation. For example, FIG. 4A shows the user 104 moving the holographic object 302 to a different location within the environment 100, e.g. to suggest a possible different place to put a vase. In this instance, updated three-dimensional positional information for the markup may be sent, to computing device 106 along with image data capturing environment 100 from a current perspective, so that the markup may be displayed as drawing 202 in the updated location on computing device 106. The user 104 also may enter additional markup via computing device 102 to send to computing device 106. FIG. 4B shows the user 104 inserting additional markup 504 in the form of an arrow indicating another possible location to which to move the picture. Hand 502 in FIGS. 4A and 4B may represent either a cursor displayed on the see-through display of computing device 102, or an actual hand of the user 104 making hand gestures. A cursor may be controlled, for example, by user inputs using motion sensors (e.g. via head gestures), image sensors (e.g. inward facing image sensors to detect eye gestures or outward facing image sensors to detect hand gestures), touch sensors (e.g. a touch sensor incorporated into a portion of the computing device 104), external input devices (e.g. a mouse, touch sensor, or other position signal controller in communication with the computing device 102), microphones (e.g. via speech inputs), or in any other suitable manner.

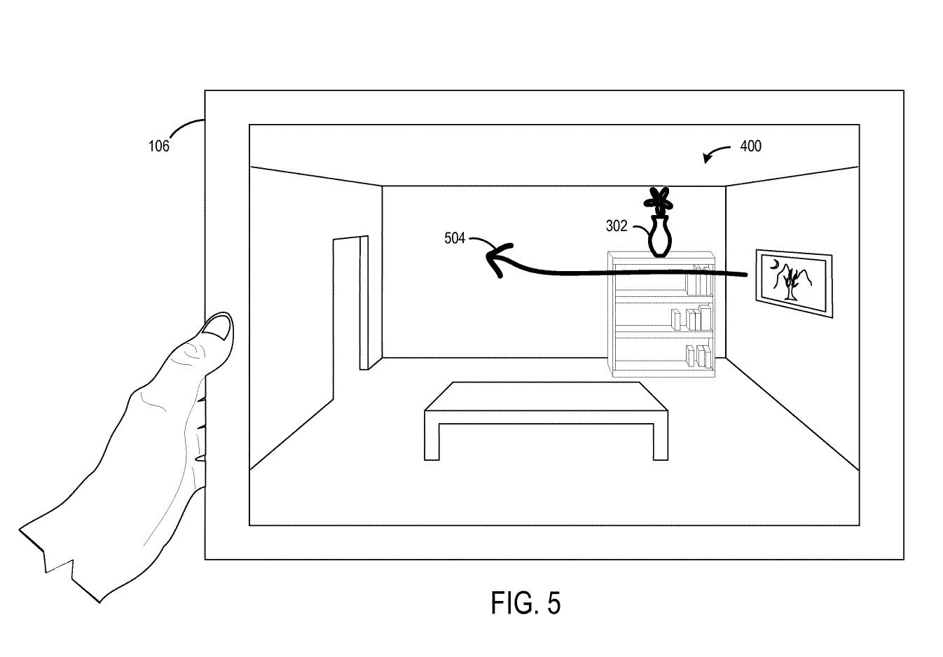

FIG. 5 shows the display device 106 displaying additional image data 400 received from the display device 102, and also displaying markup 202 and 504 at associated three-dimensional locations. The location of previous markup 204 is out of the boundaries of the image sent by the computing device 102, and as such is not viewable from this perspective. It will be understood that any suitable types of display devices other than those illustrated may be used to receive input of and display the markup along with images of the real world scene of FIG. 1, including but not limited to other wearable display devices, mobile display devices, desktop computers, laptop computers, and television displays. Further, markup may be visible at particular devices or to certain users based on privacy settings. For instance, the creator of one markup may choose to make the markup viewable to only a specified group of users.

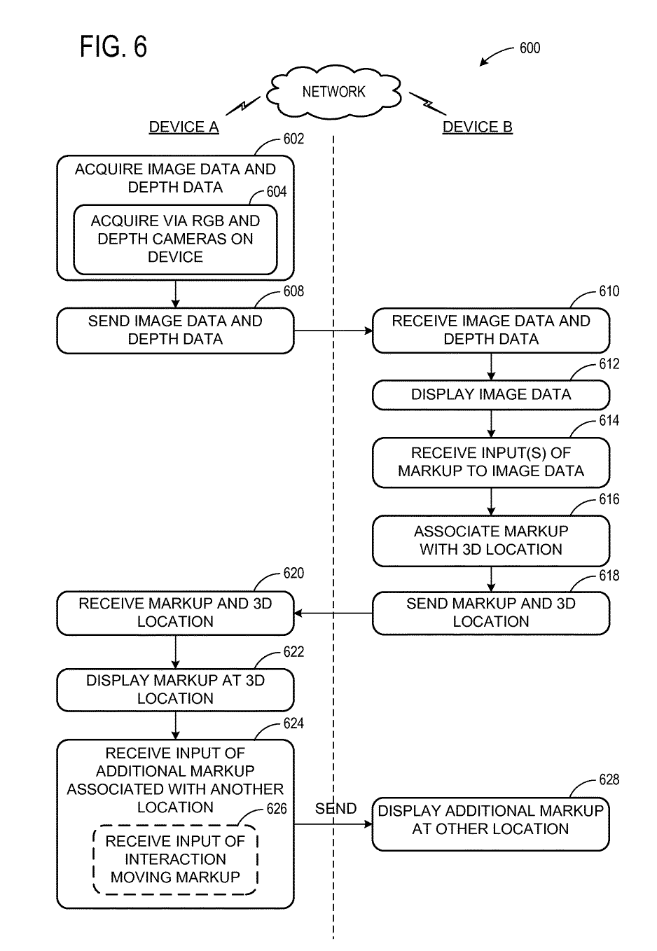

FIG. 6 illustrates an example method 600 of sharing markup made to image data between a device A and a device B. Device A and device B may represent any suitable types of computing devices, and may communicate via a network connection, as depicted schematically in FIG. 6. Further, it will be understood that either of device A and device B may share image data and/or markup with any other devices, such as with a remote server for cloud-based storage and access.

Method 600 includes, at 602, acquiring image data and associated depth data at device A for a real world scene. As described above, the image data may take any suitable form, including but not limited to RGB image data. Likewise, the depth data may take any suitable form, including but not limited to a depth map or a three-dimensional mesh representation of the real world scene or portion thereof. The image data and associated depth data may be received via cameras residing on device A, as indicated at 604, or from other sources, such as cameras located elsewhere in the environment, or from storage (e.g. for previously acquired data).

Method 600 further includes, at 608, sending the image data and depth data to device B. Device B receives the image data and depth data at 610, and displays the received image data at 612. At 614, method 600 comprises receiving one or more input(s) of markup to the image data. Any suitable input of markup may be received. For example, as described above, the input of markup may comprise an input of a drawing made by touch or other suitable input. The input of markup further may comprise an input of an image, video, animated item, executable item, text, and/or any other suitable content. At 616, method 600 includes associating each item of markup with a three-dimensional location in the real world scene. Each markup and the associated three-dimensional location are then sent back to device A, as shown at 618. As described above, the data shared between devices may also include an identifier of the real world scene. Such an identifier may facilitate storage and later retrieval of the markup, so that other devices can obtain the markup based upon the identifier when the devices are at the identified location. It will be appreciated that the identifier may be omitted in some implementations.

Method 600 further includes receiving the item(s) of markup and the associated three-dimensional location(s) at device A, as shown at 620, and displaying the item(s) of markup at the three-dimensional locations at 622. As an example, device A may display markups stereoscopically as holographic objects in the real world scene via augmented reality techniques. As another example, device A may display depth-augmented markups within a rendered image of the scene via a two-dimensional display, where device A is not a stereoscopic display (e.g. wherein device A is a mobile device with a camera and display operating in viewfinder mode).

Method 600 further includes, at 624, receiving input at device A of additional markup to the image data associated with another three-dimensional location in the scene, and sending the additional markup to device B. This may include, at 626, receiving input of new location of a previously-input item of markup, and/or the receiving newly-input markup. Method 600 further includes, at 628, displaying the additional markup via device B at the new three-dimensional location in the image.

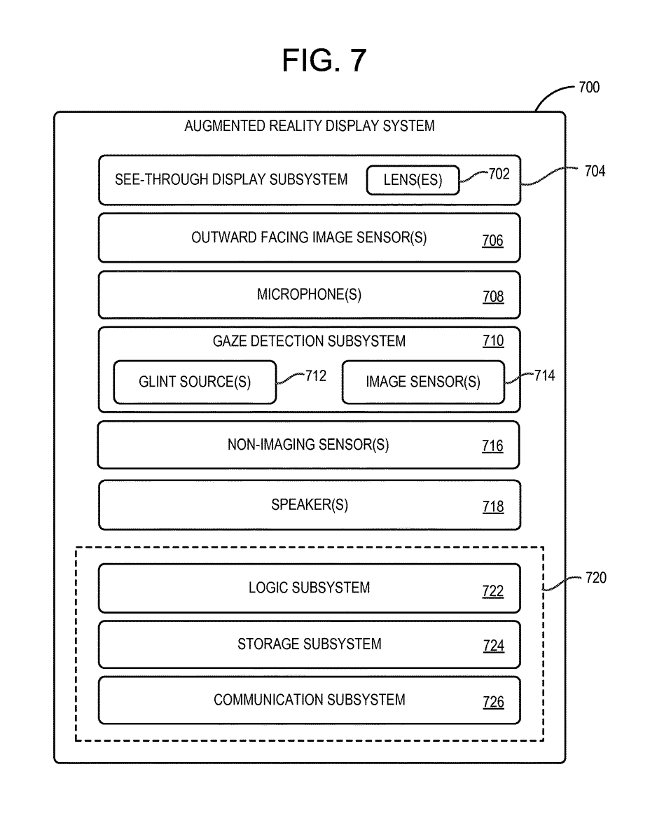

FIG. 7 shows a block diagram of an example augmented reality display system 700. Display system 700 includes one or more lenses 702 that form a part of a see-through display subsystem 704, such that images may be displayed via lenses 702 (e.g. via projection onto lenses 702, waveguide system(s) incorporated into lenses 702, and/or in any other suitable manner) while a real-world background is viewable through the lenses. Display system 700 further includes one or more outward-facing image sensors 706 configured to acquire images of a real-world environment being viewed by a user, and may include one or more microphones 708 configured to detect sounds, such as voice commands from a user or ambient sounds. Outward-facing image sensors 706 may include one or more depth sensor(s) and/or one or more two-dimensional image sensor(s) (e.g. RGB image sensors). In other examples, augmented reality display system 700, may display video-based augmented reality images via a viewfinder mode using data from an outward-facing image sensor, rather than via a see-through display subsystem.

Display system 700 may further include a gaze detection subsystem 710 configured to detect a gaze of a user for detecting user input, for example, for interacting with displayed markup and holographic objects, inputting markup, and/or other computing device actions. Gaze detection subsystem 710 may be configured to determine gaze directions of each of a user's eyes in any suitable manner For example, in the depicted embodiment, gaze detection subsystem 710 comprises one or more glint sources 712, such as infrared light sources configured to cause a glint of light to reflect from each eyeball of a user, and one or more image sensor(s) 714, such as inward-facing sensors, configured to capture an image of each eyeball of the user. Changes in the glints from the user's eyeballs and/or a location of a user's pupil as determined from image data gathered via the image sensor(s) 714 may be used to determine a direction of gaze. Gaze detection subsystem 710 may have any suitable number and arrangement of light sources and image sensors. In other examples, gaze detection subsystem 710 may be omitted.

Display system 700 also may include additional sensors, as mentioned above. For example, display system 700 may include non-imaging sensor(s) 716, examples of which may include but are not limited to an accelerometer, a gyroscopic sensor, a global positioning system (GPS) sensor, and an inertial measurement unit (IMU). Such sensor(s) may help to determine the position, location, and/or orientation of the display device within the environment, which may help provide accurate 3D mapping of the real-world environment for use displaying markup appropriately in an augmented reality setting.

Motion sensors, as well as microphone(s) 708 and gaze detection subsystem 710, also may be employed as user input devices, such that a user may interact with the display system 700 via gestures of the eye, neck and/or head, as well as via verbal commands It will be understood that sensors illustrated in FIG. 7 are shown for the purpose of example and are not intended to be limiting in any manner, as any other suitable sensors and/or combination of sensors may be utilized.

Display system 700 further includes one or more speaker(s) 718, for example, to provide audio outputs to a user for user interactions. Display system 700 further includes a controller 720 having a logic subsystem 722 and a storage subsystem 724 in communication with the sensors, gaze detection subsystem 710, display subsystem 704, and/or other components. Storage subsystem 724 comprises instructions stored thereon that are executable by logic subsystem 722, for example, to perform various tasks related to the input, sharing, and/or manipulation of depth-associated markup to images as disclosed herein. Logic subsystem 722 includes one or more physical devices configured to execute instructions. The communication subsystem 726 may be configured to communicatively couple the display system 700 with one or more other computing devices. Logic subsystem 722, storage subsystem 724, and communication subsystem 726 are described in more detail below in regard to computing system 800.

The see-through display subsystem 704 may be used to present a visual representation of data held by storage subsystem 724. This visual representation may take the form of a graphical user interface (GUI) comprising markup and/or other graphical user interface elements. As the herein described methods and processes change the data held by the storage subsystem, and thus transform the state of the storage subsystem. The state of see-through display subsystem 704 may likewise be transformed to visually represent changes in the underlying data. The see-through display subsystem 704 may include one or more display devices utilizing virtually any type of technology. Such display devices may be combined with the logic subsystem 722 and/or the storage subsystem 724 in a shared enclosure, or such display devices may be peripheral display devices.

It will be appreciated that the depicted display system 700 is described for the purpose of example, and thus is not meant to be limiting. It is to be further understood that the display system may include additional and/or alternative sensors, cameras, microphones, input devices, output devices, etc. than those shown without departing from the scope of this disclosure. For example, the display system 700 may be implemented as a virtual realty display system rather than an augmented reality system. Additionally, the physical configuration of a display device and its various sensors and subcomponents may take a variety of different forms without departing from the scope of this disclosure.

In some embodiments, the methods and processes described herein may be tied to a computing system of one or more computing devices. In particular, such methods and processes may be implemented as a computer-application program or service, an application-programming interface (API), a library, and/or other computer-program product.

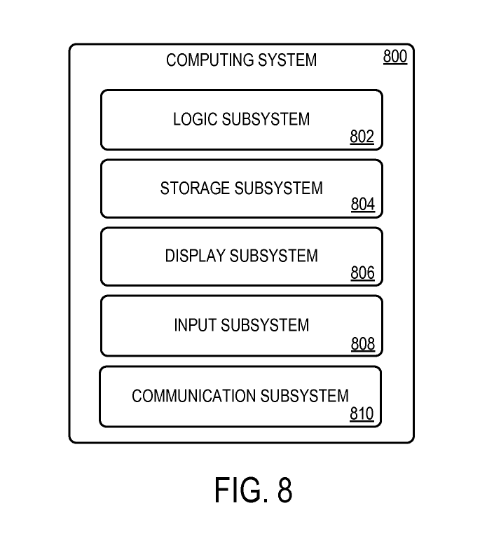

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices. For example, computing system 800 may represent augmented reality display device 102 and computing device 106, or any suitable display devices for sharing markup as disclosed herein.

Computing system 800 includes a logic subsystem 802 and a storage subsystem 804. Computing system 800 may optionally include a display subsystem 806, input subsystem 808, communication subsystem 810, and/or other components not shown in FIG. 8.

Logic subsystem 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem 802 may include one or more processors configured to execute software instructions. Additionally or alternatively, the logic subsystem 802 may include one or more hardware or firmware logic machines configured to execute hardware or firmware instructions. Processors of the logic subsystem 802 may be single-core or multi-core, and the instructions executed thereon may be configured for sequential, parallel, and/or distributed processing. Individual components of the logic subsystem 802 optionally may be distributed among two or more separate devices, which may be remotely located and/or configured for coordinated processing. Aspects of the logic subsystem 802 may be virtualized and executed by remotely accessible, networked computing devices configured in a cloud-computing configuration.

Storage subsystem 804 includes one or more physical devices configured to hold instructions executable by the logic machine to implement the methods and processes described herein. When such methods and processes are implemented, the state of storage subsystem 804 may be transformed—e.g., to hold different data.

Storage subsystem 804 may include removable and/or built-in devices. Storage subsystem 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 804 may include volatile, nonvolatile, dynamic, static, read/write, read-only, random-access, sequential-access, location-addressable, file-addressable, and/or content-addressable devices.

It will be appreciated that storage subsystem 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 802 and storage subsystem 802 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 806 may be used to present a visual representation of data held by storage subsystem 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic subsystem 802 and/or storage subsystem 804 in a shared enclosure, or such display devices may be peripheral display devices.

Input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem 810 may be configured for communication via a wireless telephone network, or a wired or wireless local- or wide-area network. In some embodiments, the communication subsystem may allow computing system 800 to send and/or receive messages to and/or from other devices via a network such as the Internet.

Another example provides, on a computing device, a method comprising receiving image data of a real world scene, receiving depth data of the real world scene, displaying the image data, receiving an input of a markup to the image data and associating the markup with a three-dimensional location in the real world scene based on the depth data, and sending the markup and the three-dimensional location associated with the markup location to another device. In this example, the input of the markup may additionally or alternatively include an input of a drawing made while displaying the image data of the real world scene. The markup may additionally or alternatively include an animated object. The markup may additionally or alternatively include one or more of an image and a video. The method may additionally or alternatively include receiving an associated identifier of the real world scene, and sending the associated identifier to the remote device. Sending the markup to the remote device may additionally or alternatively include sending the markup to a server for later retrieval. The method may additionally or alternatively include receiving additional image data of a different perspective of the real world scene, displaying the additional image data, and displaying the markup with the additional image data at a location relative to the different perspective of real world scene based upon the three-dimensional location. The method may additionally or alternatively include receiving from the remote device an input of additional markup to the image data associated with another three-dimensional location, and displaying the additional markup with the image data at the other three-dimensional location.

Another example provides an augmented reality display system comprising a see-through display through which a real world scene is viewable, a camera, a depth sensor, a logic subsystem, and a storage subsystem comprising stored instructions executable by the logic subsystem to acquire image data of the real world scene via the camera, acquire depth data of the real world scene via the depth sensor system, send to another device the image data and the depth data, receive from the remote device markup to the image data associated with a three-dimensional location, and display the markup via the see-through display at the three-dimensional location associated with the markup relative to the real world scene. In this example, the markup may additionally or alternatively include a drawing. The instructions may additionally or alternatively be executable to receive an input of an interaction with the markup, and to modify display of the markup based upon the interaction. The interaction with the markup may additionally or alternative include an input of a movement of the markup, and the instructions may additionally or alternatively be executable to associate the markup with an updated three-dimensional location in response to the input. The instructions may additionally or alternatively be executable to obtain an associated identifier of the real world scene, and send the associated identifier to the remote device. The remote device may additionally or alternatively include a server. The instructions may additionally or alternatively be executable to display the markup via the see-through display as a holographic object. The instructions may additionally or alternatively be executable to receive a user input of additional markup to the image data associated with another location in the real world scene, and send the additional markup to the other device.

Another example provides a computing system, comprising a display device, a logic subsystem, and a storage subsystem comprising stored instructions executable by the logic subsystem to receive image data of a real world scene, receive depth data of the real world scene, display the image data, receive an input of markup to the image data, associate the markup with a three-dimensional location in the real world scene based on the depth data, and send the markup and the three-dimensional location associated with the markup to another device. The instructions may additionally or alternatively be executable to receive the input in the form of a drawing while displaying the image data of the real world scene. The instructions may additionally or alternatively be executable to receive additional image data of a different perspective of the real world scene, display the additional image data, and display the markup with the additional image data at a location relative to the different perspective of real world scene based upon the three-dimensional location associated with the markup. The instructions may additionally or alternatively be executable to receive the image data and the depth data from the remote device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method comprising:
receiving image data of a real world scene;
receiving depth data of the real world scene;
displaying the image data;
receiving an input of a markup to the image data and associating the markup with a three-dimensional location in the real world scene based on the depth data; and
sending the markup and the three-dimensional location associated with the markup location to another device.

2. The method of claim 1, wherein the input of the markup comprises an input of a drawing made while displaying the image data of the real world scene.

3. The method of claim 1, wherein the markup comprises an animated object.

4. The method of claim 1, wherein the markup comprises one or more of an image and a video.

5. The method of claim 1, further comprising receiving an associated identifier of the real world scene, and sending the associated identifier to the remote device.

6. The method of claim 1, wherein sending the markup to the remote device comprises sending the markup to a server for later retrieval.

7. The method of claim 1, further comprising receiving additional image data of a different perspective of the real world scene, displaying the additional image data, and displaying the markup with the additional image data at a location relative to the different perspective of real world scene based upon the three-dimensional location.

8. The method of claim 1, further comprising receiving from the remote device an input of additional markup to the image data associated with another three-dimensional location, and displaying the additional markup with the image data at the other three-dimensional location.

9. An augmented reality display system, comprising:
a see-through display through which a real world scene is viewable;
a camera;
a depth sensor;
a logic subsystem; and
a storage subsystem comprising stored instructions executable by the logic subsystem to
acquire image data of the real world scene via the camera,
acquire depth data of the real world scene via the depth sensor system,
send to another device the image data and the depth data,
receive from the remote device markup to the image data associated with a three-dimensional location, and
display the markup via the see-through display at the three-dimensional location associated with the markup relative to the real world scene.

10. The system of claim 9, wherein the markup comprises a drawing.

11. The system of claim 9, wherein the instructions are further executable to receive an input of an interaction with the markup, and to modify display of the markup based upon the interaction.

12. The system of claim 11, wherein interaction with the markup is an input of a movement of the markup, and wherein the instructions are executable to associate the markup with an updated three-dimensional location in response to the input.

13. The system of claim 9, wherein the instructions are further executable to obtain an associated identifier of the real world scene, and send the associated identifier to the remote device.

14. The system of claim 9, wherein the remote device comprises a server.

15. The system of claim 9, wherein the instructions are executable to display the markup via the see-through display as a holographic object.

16. The system of claim 9, wherein the instructions are further executable to receive a user input of additional markup to the image data associated with another location in the real world scene, and send the additional markup to the other device.

17. A computing system, comprising:
a display device;
a logic subsystem; and
a storage subsystem comprising stored instructions executable by the logic subsystem to:
receive image data of a real world scene,
receive depth data of the real world scene,
display the image data,
receive an input of markup to the image data,
associate the markup with a three-dimensional location in the real world scene based on the depth data, and
send the markup and the three-dimensional location associated with the markup to another device.

18. The computing system of claim 17, wherein the instructions are executable to receive the input in the form of a drawing while displaying the image data of the real world scene.

19. The computing system of claim 17, wherein the instructions are further executable to receive additional image data of a different perspective of the real world scene, display the additional image data, and display the markup with the additional image data at a location relative to the different perspective of real world scene based upon the three-dimensional location associated with the markup.

20. The computing system of claim 17, wherein the instructions are further executable to receive the image data and the depth data from the remote device.
